(19) United States
(12) Patent Application Publication
(10) Pub. No.: US 2016/0231143 A1
(43) Pub. Date: Aug. 11, 2016

(54) POSITION MEASUREMENT ENCODER

(71) Applicant: RENISHAW PLC, Gloucestershire (GB)

(72) Inventor: Simon Eliot MCADAM, Nailsworth (GB)

(73) Assignee: RENISHAW PLC, Gloucestershire (GB)

(21) Appl. No.: 15/024,213

(22) PCT Filed: Sep. 26, 2014
(86) PCT No.: PCT/EP2014/070607

§ 371 Date: Mar. 23, 2016

(30) Foreign Application Priority Data
Oct. 1, 2013 (EP) 13275236.1

(51) Int. Cl. G01D 5/347

(52) U.S. Cl. CPC G01D 5/34715

(57) ABSTRACT

Encoder apparatus enabling relative position measurement between a scale and a readhead along a measurement direction. The scale includes features that define a series of incremental scale marks and at least one reference mark. The readhead includes a light source for illuminating the incremental scale marks and at least one reference mark and at least one reference mark photodetector channel. The at least one reference mark is configured to provide an increase in light from the common light source reaching the at least one reference mark photodetector channel at the at least one reference position. The at least one reference mark and/or the at least one reference mark photodetector channel can be featured to interact with light from the common light source non-uniformly across its extent in a dimension perpendicular to the measurement direction to reduce the intensity of light detected by the at least one reference mark photodetector channel.

The present invention relates to a position measurement encoder, and in particular to a particular arrangement of a reference mark detector used in a readhead of a measurement encoder.

As will be understood, a measurement encoder typically comprises a scale comprising features and a readhead for reading the features so as to be able to determine relative position of the readhead and scale. The scale and readhead are moveable relative to each other.

Incremental encoders are known wherein the scale comprises a series of incremental features which the readhead can read to determine and measure relative motion. As will be understood, various techniques can be used to read the incremental features, including simple imaging of the incremental features and counting the features as they pass the readhead.

Many incremental encoders rely on the use of a combination of gratings arranged to diffract light so as to produce optical patterns at a detector which changes as the readhead and scale move relative to each other. Examples of a typical incremental encoder produced by Renishaw plc are available under the brand names TONiC™ and SiGNUM™. In the TONiC™ and SiGNUM™ readheads a lens is used to substantially collimate light from the source. They also comprise a diffraction grating (which is a phase grating), and a photodetector array. In operation, collimated light from the light source the interacts with the scale (which is an amplitude grating) to produce diffraction orders, which in turn interact with the diffraction grating to produce at the photodetector array an interference fringe pattern which moves with relative movement of the scale and readhead.

Often, one or more reference marks are provided (e.g. embedded within or next to the series of incremental features, either on the same scale substrate or next to it) such that relative position can be determined with respect to known reference position(s) defined by the reference mark(s). A reference photodetector is provided in the readhead to read the reference mark(s). In an optical encoder (e.g. an encoder in which light in the infra-red to ultraviolet range is used) a reference mark can provide an increase or decrease in the light received at the reference photodetector.

A known optical encoder is the TONiC™ encoder available from Renishaw® plc. The TONiC encoder comprises an incremental scale with an embedded dark-line reference mark (i.e. the reference mark reduces the intensity of light reaching its reference mark photodetector channels). Due to the physical arrangement of the readhead electronics and in particular the incremental and reference mark photodetectors, incremental signal lines pass over a constricted part of the reference mark photodetector channels.

The present invention provides an encoder apparatus comprising a scale having a at least one reference mark and a readhead for reading the scale, in which the reference mark and/or a reference mark detector in the readhead is featured (e.g. comprises light restriction features) so as to reduce the intensity of light detected by the at least one reference mark photodetector channel, in particular such that the output from the at least one reference mark photodetector channel is at or below the saturation point of at least one reference mark photodetector channel electronics.

Accordingly there is provided an encoder apparatus for enabling relative position measurement between a scale and a readhead along a measurement direction. The scale comprises features that define a series of incremental scale marks and at least one reference mark (defining a reference position). The readhead comprises a (e.g. a common) light source for illuminating the incremental scale marks and at least one reference mark, at least one incremental photodetector, and at least one reference mark photodetector channel. The at least one reference mark is configured to provide an increase in light from the common light source reaching the at least one reference mark photodetector channel at the at least one reference position (with respect to the track in which it is contained). The at least one reference mark and/or the at least one reference mark photodetector channel can be featured so as to interact with light from the common light source non-uniformly across its extent in a dimension perpendicular to the measurement direction, so as to reduce the intensity of light detected by the at least one reference mark photodetector channel.

According to a first aspect of the invention there is provided an encoder apparatus for enabling relative position measurement between a scale and a readhead along a measurement direction, in which: the scale comprises features that define a series of incremental scale marks and a reference mark defining a reference position along the measurement direction; the readhead comprises a common light source for illuminating the incremental and reference marks, at least one incremental photodetector, and at least one reference mark photodetector channel, in which the reference mark is configured to provide an increase in light from the common light source reaching the at least reference mark photodetector channel at the reference position and in which: the reference mark is featured such that, within a notional rectangular region that has sides parallel and perpendicular to measuring dimension, the position of the sides being defined by the reference mark's extent in and perpendicular to the measurement dimension, there is non-uniform propagation of light intensity from the common light source toward the at least one reference mark photodetector channel at least in a dimension perpendicular to the measurement direction; and/or, the at least one reference mark photodetector channel is featured such that, within a notional rectangular region that has sides parallel and perpendicular to measuring dimension, the position of the sides being defined by the reference mark photodetector channel's extent in and perpendicular to the measurement dimension, the at least one reference mark photodetector channel is non-uniformly sensitive at least in a dimension perpendicular to the measurement direction.

As will be understood, a rectangle comprises a parallelogram with four right angles (i.e. an equiangular quadrilateral) and hence includes a square. It has been found that reference marks that are configured to provide an increase in intensity of the light from the common light source reaching the at least one reference mark photodetector channel (e.g. a “bright” reference mark) can provide greater dirt immunity over reference marks that are configured to reduce the intensity of the light from the common light source reaching the at least one reference mark photodetector channel (e.g. a “dark” reference mark). This can be, for example, because dirt/contamination is more likely to absorb light rather than reflect it.

It has been found that such an arrangement in which the reference mark and/or the at least one reference mark photodetector channel are featured so as to interact with light from the common light source non-uniformly across its extent in a dimension perpendicular to the measurement direction can help to avoid over saturation of the reference mark photodetector channel electronics, whilst not significantly affecting dirt immunity. As will be understood, an alternative to the present invention would be to provide a uniform reference mark photodetector channel of reduced size/overall footprint (i.e. the area of the notional rectangular region) of the reference mark and/or the reference mark photodetector channel. However, it has been found that reducing the size/overall footprint (i.e. the area of the notional rectangular region) makes the reference mark detection system much less dirt immune (whereas by dealing with over saturation according to our invention has been found to help maintain the dirt immunity of the reference mark detection system).

The incremental photodetector and the at least one reference mark photodetector channel can share common electronics for handling their output. For example the at least one reference mark photodetector channel and the incremental photodetector can share a common integrated circuit which handles the outputs from the incremental photodetector and at least one reference mark photodetector channel (e.g. an Application Specific Integrated Circuit (ASIC)). As will be understood, such electronics (e.g. an ASIC) could process, combine and/or amplify signals from the incremental photodetector and/or at least one reference mark photodetector channel. Sharing common electronics can be advantageous, for example because a common gain and bandwidth can be achieved, resulting in a common response time for the incremental and reference mark channels, helping to keep them in phase and hence maintaining accuracy of the encoder apparatus. However, it has been found that in such embodiments, over saturation, in particular of the part handling the output of the at least one reference mark photodetector channel can be more likely.

Accordingly, in the case of the reference mark photodetector channel, it could be, for example, that the total sensing area of the channel is less than the notional rectangular region defined by the extents of the reference mark photodetector channel in and perpendicular to the measuring dimension.

Preferably, the apparatus is configured such that the output from the at least one reference mark photodetector channel is at or below the saturation point of the at least one reference mark photodetector channel's electronics (e.g. downstream/processing electronics).

Optionally, said feature(s) splits the reference mark and/or the at least one reference mark detector channel into at least two sections, optionally at least three sections, for example at least four sections. Preferably, said feature(s) splits the reference mark and/or the at least one reference mark detector channel into section in a direction perpendicular to the measuring direction

The reference mark can configured such that within the notional rectangular region its light propagation profile in a direction parallel to the measuring dimension is substantially uniform. Accordingly, the reference mark can be configured such that the intensity of light it propagates towards the reference mark photodetector channel is substantially uniform across its width (e.g. in a direction parallel to the measuring dimension). In the case of a reflective reference mark, the reference mark can configured such that its light reflectance profile (that is the amount of light it reflects toward the at least one reference mark photodetector) in a direction perpendicular to the measuring dimension is substantially uniform.

The reference mark can configured such that within the notional rectangular region its light propagation profile in a direction perpendicular to the measuring dimension is substantially non-uniform. Accordingly, the reference mark can be configured such that the intensity of light it propagates towards the reference mark photodetector channel is substantially non-uniform (e.g. varies) along its length (e.g. in a direction perpendicular to the measuring dimension). In the case of a reflective reference mark, the reference mark can configured such that its light reflectance profile (that is the amount of light it reflects toward the at least one reference mark photodetector) in a direction perpendicular to the measuring dimension is substantially non-uniform.

Optionally, the at least one reference mark photodetector channel is configured such that within the notional rectangular region its light sensitivity profile in a direction perpendicular to the measuring dimension is substantially non-uniform (e.g. varies). Optionally, the at least one reference mark photodetector channel is configured such that its light sensitivity profile in a direction parallel to the measuring dimension is substantially uniform.

The reference mark and/or the at least one reference mark photodetector channel can comprise at least one (e.g. discrete) light restriction region which reduces the intensity of light detected by the at least one reference mark detector channel. In other words, the at least one reference mark photodetector channel is configured such that the notional rectangular region comprises at least one discrete light restriction region having relatively reduced sensitivity, and/or the at least one reference mark comprises at least one discrete light restriction region having relatively reduced light intensity propagation properties toward the at least one reference mark photodetector. Said light restriction region can comprise at least 10% of the area of notional rectangular region of the reference mark or of the at least one reference mark detector channel, preferably at least 25%, more preferably at least 35%, for example at least 45% or more.

The at least one light restriction region could be configured such that it substantially blocks light (e.g. such that the light falling on said at least one region is prevented from being detected by the at least one reference mark photodetector channel). As will be understood, such blocking can be achieved in numerous ways, including by way of example only, absorption, reflection, and deflection. For example the at least one region could be configured such that it blocks at least 75%, more preferably at least 85%, especially preferably more than 95% of light incident on it. However, as will be understood, this need not necessarily be the case, for instance the at least one region could be configured to only partially block light, for instance block not more than 75%, for example not more than 50% of light incident on it.

As mentioned above, the at least one reference mark photodetector channel can comprise said at least one (e.g. discrete) light restriction region. Optionally, at least one (e.g. discrete) light restriction region comprises a region of the at least one reference mark detector channel that is disabled such that light falling on it does not contribute to the signal output by the reference mark detector channel. Optionally, at least one light restriction region of the at least one reference mark detector channel is masked so as to prevent light from reaching a region of the reference mark detector channel. For example, a metallisation layer can be applied over a region of the at least one reference mark detector channel so as to at least partially, and optionally substantially, block light from reaching the photo sensitive part of the at reference mark detector channel.

The reference mark and/or the at least one reference mark photodetector channel can comprise at least one band, e.g. an elongate band, which reduces the intensity of light detected by the at least one reference mark detector channel (e.g. it is a light restriction band). In other words, the at least one reference mark photodetector channel is configured such that the notional rectangular region comprises at least one band of relatively reduced sensitivity, and/or the at least one reference mark comprises at least one light restriction band. The at least one band can extend along the reference mark and/or at least one reference mark detector channel, in the encoder apparatus' measuring dimension. In other words, preferably the longitudinal extent of the at least one (elongate) band does not extend perpendicularly to the encoder's measuring dimension. Optionally, the (longitudinal extent of the) at least one band can extend parallel to the measuring dimension. It can be preferred that the at least one band has parallel edges (for example, the at least one band can be substantially rectangular in shape) and for example that those edges extend parallel to the measuring dimension. It can be preferred that the at least one band extends substantially all the way across the at least one reference mark detector channel, e.g. from edge-to-edge or side-to-side.

The at least one light restriction region on the reference mark can prevent light from being propagated toward the at least one reference mark photodetector channel. Optionally, at least one light restriction region on the at least one reference mark photodetector channel is substantially insensitive to light. In other words, the at least one light restriction region of the at least one reference mark photodetector channel can be substantially insensitive to light and/or the at least one light restriction region of the at least one reference mark can substantially prevent light from reaching the at least one reference mark photodetector channel (e.g. via absorption, reflection and/or deflection).

The readhead can comprise at least two reference mark photodetector channels. The at least two reference mark photodetector channels can be offset in the measuring direction. Accordingly, the at least two reference mark photodetector channels can be arranged in an array that extends along the measuring direction, e.g. parallel to the measuring direction. Accordingly, the at least two reference mark detector channels can be non-overlapping. Accordingly, the notional rectangular regions defined by each of the at least two reference mark detector channels can be non-overlapping.

The total sensitivity of the at least two reference mark detector channels can be the same. The total area of the at least one (e.g. discrete) light restriction region can be substantially the same for the at least two reference mark detector channels. As will be understood, the arrangement/pattern of said light restriction region need not be identical. However, it can be preferred if the at least two reference mark detector channels do have the same arrangement of said at least one region of reduced sensitivity. Accordingly, optionally, the at least one band can extend across all of said detector channels in said array.

The common light source could emit light in the visible range. As will be understood, suitable light sources include those that emit light anywhere in the infra-red to the ultraviolet range of the electromagnetic spectrum. Optionally, the common light source emits light in the infra-red range.

The apparatus can be configured to obtain a difference signal of signals obtained from the at least two detector channels in order to determine the reference position. This could for example be the difference signal from the direct output of the at least two detector channels. Optionally, the apparatus is configured to obtain a difference signal between first and second groups of a plurality (e.g. first and second pairs) of detector channels in order to determine the reference position. Optionally, a difference signal between a different combination of detector channels is used to determine a gating signal which can be used to aid identification of the reference position.

The readhead can comprise a diffraction grating. Light from the common light source can interacts with the incremental scale marks and the at least one diffraction grating to produce diffraction orders which combine to produce at the at least one photodetector a resultant field which varies with relative movement of the scale and readhead.

As will be understood, the common light source could comprise one or more light emission components. Accordingly, as will be understood, the common light source can comprise one or more light emitters. For instance, the common light source can comprise one or more light emitting diodes (LEDs). The common light source can comprise a divergent light source (e.g. can produce a divergent light beam). Optionally, the optical power (in dioptres, m⁻¹) of any optical components in the optical path between the light emission component and reference mark photodetector channel can be between −100 and 100, for example between −50 and 50, for instance between −10 and 10, in particular between −5 and 5. Optionally, the optical power (in dioptres) of any optical component in the optical path between the light emission component and the reference photodetector is substantially 0. Accordingly, optionally, no lens is provided in the optical path between the light emission component of the common light source, and the at least one reference mark photodetector channel.

The apparatus can be configured such that the reference mark as resolvable by the at least one reference mark photodetector channel comprises a single feature.

Accordingly, this application describes an encoder apparatus comprising: a scale comprising features which define a series of incremental scale marks and a reference mark defining a reference position; a readhead comprising a reference mark photodetector comprising at least one detector channel for detecting the reference mark, in which the sensitivity of the at least one detector channel is non-uniform across its extent.

According to a further aspect of the invention there is provided a readhead for reading a scale along a measurement direction, the readhead comprising a light source for illuminating a scale, an incremental photodetector for reading incremental scale marks on the scale, and at least one reference mark detector channel for detecting at least one reference mark on the scale, in which the at least one reference mark detector channel comprises at least one (e.g. elongate) band of reduced sensitivity which extends parallel to the readhead's measurement dimension.

According to another aspect of the invention there is provided an encoder apparatus for enabling relative position measurement between a scale and a readhead along a measurement direction, comprising: a scale comprising incremental scale marks and at least one reference mark; a readhead comprising a light source for illuminating the incremental and reference marks, an incremental photodetector for reading the incremental scale marks, and at least one reference mark detector channel for detecting the at least one reference mark; in which the at least one reference mark detector channel comprises at least one (e.g. elongate) band of reduced sensitivity extending parallel to the measurement dimension.

This application also describes an incremental encoder apparatus comprising: a scale comprising features which define a series of incremental scale marks and a reference mark contained in a separate track to the incremental scale marks; a readhead comprising a diffraction grating, an incremental photodetector, a reference mark photodetector, and a non-collimated light source positioned between the incremental photodetector and the reference mark photodetector in a direction transverse to the reading direction of the readhead, for producing a divergent light beam for illuminating the series of incremental scale marks and the reference mark, in which the divergent light beam interacts first with the series of incremental scale marks to produce a first set of diffraction orders which then interact with the diffraction grating to produce further diffraction orders which combine to produce an interference fringe at the incremental photodetector which changes with relative movement of the scale and readhead.

The apparatus can be configured such that the divergent light beam can pass through at least a part of the diffraction grating on the way to the scale but does not interact with it to produce diffraction orders.

The reference mark photodetector can comprise at least one detector channel. The sensitivity of which can be non-uniform across its extent in a dimension perpendicular to the measurement direction. For instance the at least one detector channel can have at least one band of reduced sensitivity. The at least one band of reduced sensitivity can extend along the at least one detector channel, e.g. in a direction parallel to the measurement direction.

The reference mark photodetector can comprise a series of separate detector channels arranged in an array. The array can comprise a directional component that extends parallel to the measurement direction.

The incremental photodetector can comprises a series of separate photodetector elements arranged in an array. The array can comprise a directional component that extends parallel to the measurement direction (e.g. the measurement direction of the readhead).

Preferably, the optical power (in dioptres, m⁻¹) of any optical components in the optical path between the light emission component and reference mark photodetector channel within the readhead is between −100 and 100, for example between −50 and 50, for instance between −10 and 10, in particular between −5 and 5. Optionally, the optical power (in dioptres, m⁻¹) of any optical component in the optical path between the light emission component and reference mark photodetector channel within the readhead is substantially 0.

Optionally, the optical power (in dioptres, m⁻¹) of any optical components in the readhead is between −100 and 100, for example between −50 and 50, for instance between −10 and 10, in particular between −5 and 5, for example substantially 0.

Optionally, the scale reflects light from the light source towards the incremental and reference mark photodetectors.

The reference mark can comprises a feature which allows relatively more light to reach the reference mark photodetector compared to the non-reference mark part of the reference mark track. For example, the reference mark can be contained in a track and can be more reflective than the other parts of the track.

Optionally, the readhead is configured to operate such that the distance between the scale and the incremental photodetector is not more than 6 mm, for example not more than 5 mm, for instance not more than 4.5 mm, in particular not more than 4.2 mm. Optionally, the distance between the incremental photodetector and the diffraction grating is not more than 3 mm, for example not more than 2.8 mm, for instance not more than 2.3 mm.

The incremental and reference mark photodetectors and the light source can all be mounted on a common planar surface. For example, they can all be mounted onto a common printed circuit board (PCB).

This application also describes an incremental (e.g. two-grating) encoder apparatus comprising: a scale; a readhead comprising: a non-collimated light source for producing a divergent light beam; a diffraction grating; and a photodetector array; configured such that the divergent light beam interacts with the scale and then with the diffraction grating to produce an interference fringe at the photodetector array which changes with relative movement of the scale and readhead, and characterised in that the optical power (in dioptres, m⁻¹) of all optical components in the path between the light source and the photodetector array is between −100 and 100, for example between −50 and 50, for instance between −10 and 10, in particular between −5 and 5.

Accordingly, in the case of a diverging beam, the light beam's divergence can remain substantially unaltered throughout said path.

This application further describes, an encoder apparatus comprising: a scale; and a readhead comprising: a light source; a diffraction grating; and a photodetector array; configured such that light field from the light source interacts with the scale and then with the diffraction grating to produce an interference fringe at the photodetector array which changes with relative movement of the scale characterised in that the encoder apparatus is without an optical device, for example a lens, that alters the wavefront curvature of the light from the light source.

Embodiments of the invention will now be described, by way of example only, with reference to the following drawings in which:

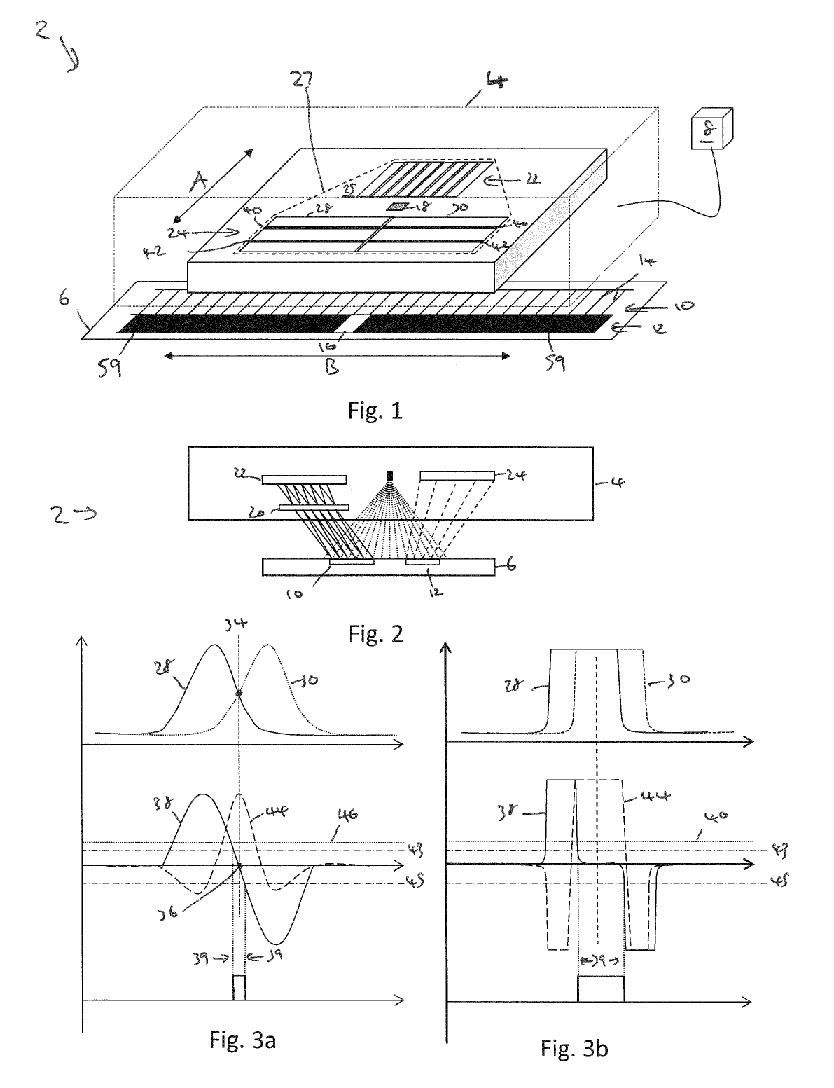

FIG. 1 is a schematic isometric diagram of a reflective encoder according to the present invention;

FIG. 2 is a schematic cross-sectional view of the encoder of FIG. 1, looking along the length of the scale;

FIG. 3a is a graph illustrating the detecting of a reference position for the encoder of FIG. 1;

FIG. 3b is a graph illustrating the detecting of a reference position for an encoder in which the reference mark detector is saturated by the light from the reference mark;

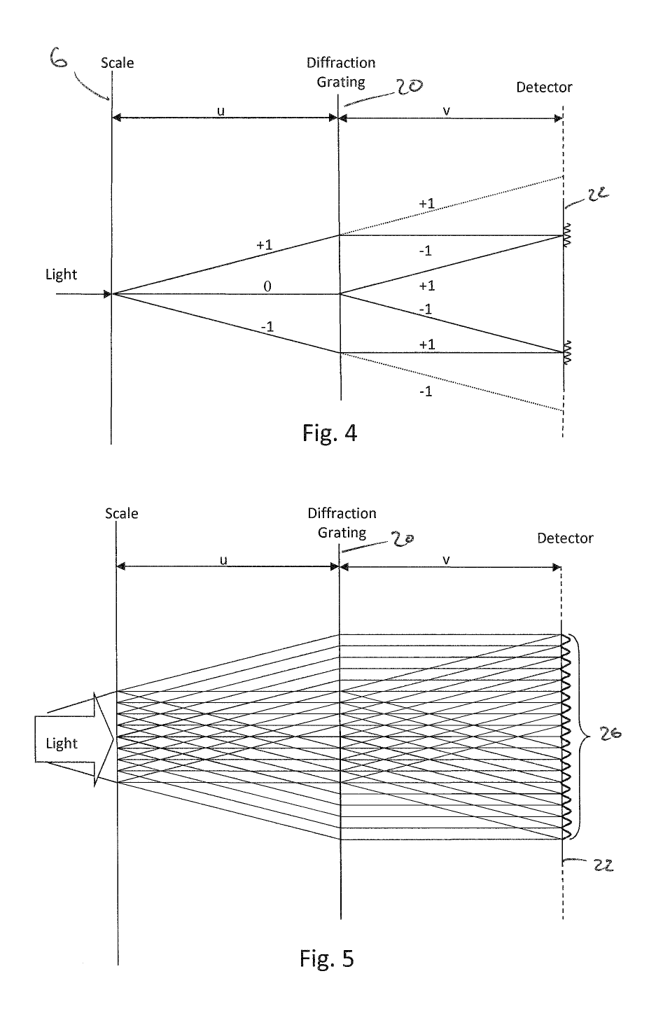

FIGS. 4 and 5 are schematic ray diagrams schematically illustrating the generation of a resultant field at the incremental photodetector via the use of diffracted light so as to facilitate incremental reading of the readhead position;

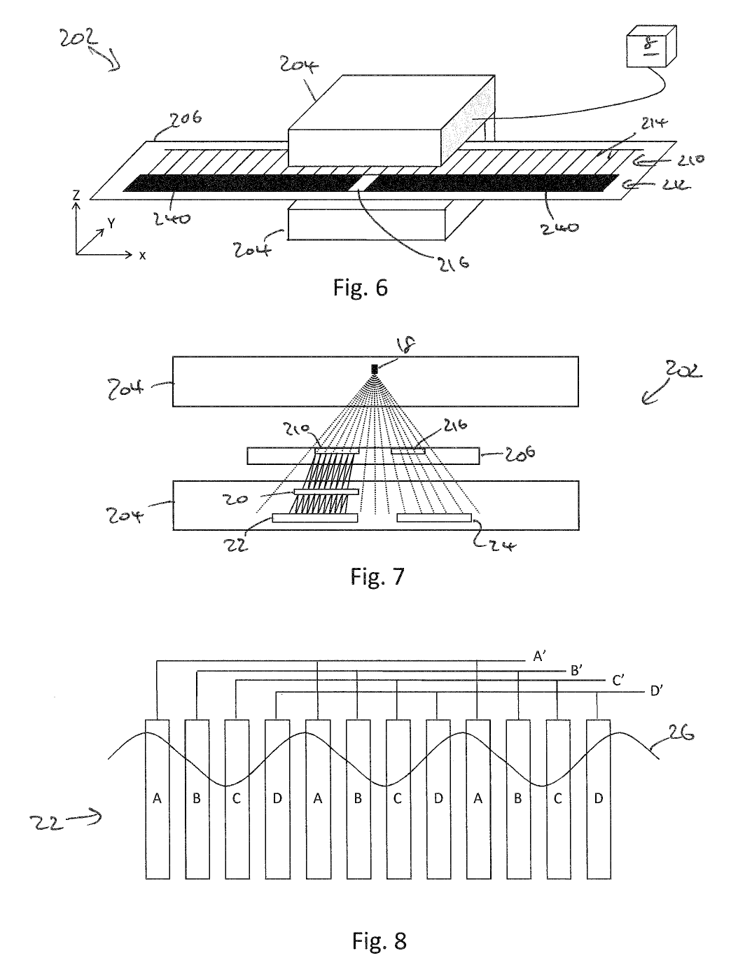

FIG. 6 is a schematic isometric diagram of a transmissive encoder according to another embodiment of the present invention;

FIG. 7 is a schematic cross-sectional view of the encoder of FIG. 6, looking along the length of the scale;

FIG. 8 is a schematic drawing of one type of incremental detector suitable for use in a readhead according to the invention;

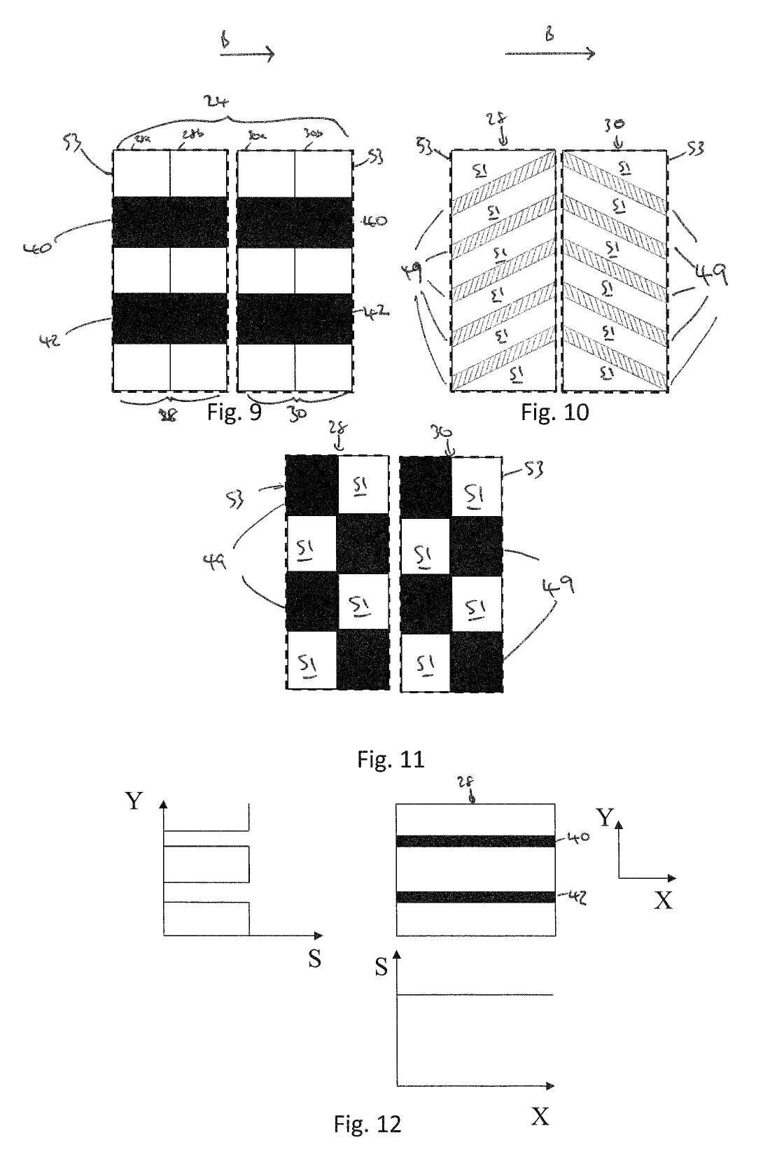

FIG. 9 is a schematic plan view of a reference photodetector according to an alternative embodiment of the invention;

FIG. 10 is a schematic plan view of a reference photodetector according to yet another embodiment of the invention;

FIG. 11 is a schematic plan view of a reference photodetector according to a further embodiment of the invention; and

FIG. 12 schematically illustrates the light sensitivity profile of the first channel of the reference photodetector in both the X and Y dimensions.

With reference to FIGS. 1 and 2 there is shown an encoder apparatus 2 according to the present invention. The encoder apparatus comprises a readhead 4 and a scale 6. Although not shown, typically in practice the readhead 4 will be fastened to one part of a machine and the scale 6 to another part of the machine which are movable relative to each other. The readhead 4 is used to measure the relative position of itself and the scale 6 and hence can be used to provide a measure of the relative position of the two movable parts of the machine. Typically, the readhead 4 communicates with a processor such as a controller 8 via a wired (as shown) and/or wireless communication channel. The readhead 4 can report the signals from its detectors (described in more detail below) to the controller 8 which then processes them to determine position information and/or the readhead 4 can itself process the signals from its detectors and send position information to the controller 8.

The scale 6 comprises a plurality of scale markings defining an incremental track 10, and a reference track 12.

The incremental track 10 comprises a series of periodic scale marks 14 which control the light transmitted toward the readhead to effectively form a diffraction grating. The incremental track 10 could be what is commonly referred to as an amplitude scale or a phase scale. As will be understood, if it is an amplitude scale then the features are configured to control the amplitude of light transmitted toward the readhead's incremental detector (e.g. by selectively absorbing, scattering and/or reflecting the light). As will be understood, if it is a phase scale then the features are configured to control the phase of light transmitted toward the readhead's incremental detector (e.g. by retarding the phase of the light). In the present embodiment, the incremental track 10 is an amplitude scale, but in either case, as explained in more detail below, the light interacts with the periodic scale marks 14 to generate diffracted orders.

The reference track 12 comprises a reference position defined by a reflective reference mark 16. The rest of the track comprises features 59 which absorb light. Accordingly, the reference position is defined by a mark which permits relatively more light to reach the reference mark photodetector 24 (described below) than the rest of the track in which it is contained, and in this case is relatively more reflective than the rest of the track in which it is contained. Reference positions can be useful to enable the readhead 4 to be able to determine exactly where it is relative to the scale 6. Accordingly, the incremental position can be counted from the reference position. Furthermore, such reference positions can be what are also referred to as “limit positions” in that they can be used to define the limits or ends of the scale 6 between which the readhead 4 is permitted to travel.

In this embodiment, the encoder apparatus is a reflective encoder in that it comprises an electromagnetic radiation (EMR) source 18, e.g. an infra-red light source 18, and at least one detector (described in more detail below) on the same side of the scale 6. In general, infra-red light from the light source 18 is configured to be reflected by the scale 6 back toward the readhead. As illustrated, the light source 18 is divergent and the light source's illumination footprint falls on both the incremental track 10 and the reference track 12. In the embodiment described, the light source 18 emits EMR in the infra-red range, however as will be understood, this need not necessarily be the case and could emit EMR in other ranges, for example anywhere in the infra-red to the ultra-violet. As will be understood, the choice of a suitable wavelength for the light source 18 can depend on many factors, including the availability of suitable gratings and detectors that work at the electromagnetic radiation (EMR) wavelength. As also illustrated, the readhead 4 also comprises a diffraction grating 20 (also commonly referred to as an index grating), an incremental photodetector 22 and a reference photodetector 24.

In the embodiment described, the light source 18 is a Light Emitting Diode (“LED”).

As shown, the light source 18 is positioned between the incremental photodetector 22 and the reference photodetector 24, in a direction (illustrated by arrow A) transverse to the reading direction (illustrated by arrow B) of the readhead. This facilitates good even illumination of both the incremental track 10 and reference mark track 12. In particular, in this embodiment, the light source 18 is positioned substantially equidistantly between the incremental photodetector 22 and the reference photodetector 24, and is contained within an area 25 defined by the outer extents of the readhead's 4 incremental 22 and reference mark 24 photodetectors (schematically illustrated by the dashed line 27).

These components will be explained in more detail below, but in summary, the light from the from the light source 18 is emitted from the readhead 4 toward the scale 6, where part of the light source's 18 footprint interacts with the reference track 12 and part of the light source's footprint interacts with the incremental track 10. In the currently described embodiment, the reference position is defined by a feature 16 in the reference mark track 12 which increases the intensity of light from the light source 18 which is reflected back toward the reference photodetector 24 compared to the rest of the track in which the reference mark is contained. This could be achieved, for example, by the features 59 in the rest of the reference mark track 12 absorbing, transmitting and/or scattering more light than the reference mark 16. In this case, the light features 59 absorb the light from the light source. In any case, a shadow of the scale's mark(s) defining the reference position (in this case the features 59) is therefore cast on the reference detector 24 when the readhead is not over the reference position. In particular, in this embodiment, the feature 16 reflects light from the source 18 incident on it back toward the reference photodetector 24. In the position illustrated in FIG. 2, the readhead 4 is aligned with the reference position and so the light is shown as being reflected back toward the reference photodetector 24.

With respect to the incremental track 10, light from the source 18 falls on the periodic scale marks 14 which define a diffraction pattern. The light therefore diffracts into multiple orders, which then fall onto the diffraction grating 20 in the readhead 4. In the present embodiment, the diffraction grating 20 is a phase grating. The light is then further diffracted by the diffraction grating 20 into orders which then interfere at the incremental photodetector 22 to form a resultant field, in this case an interference fringe.

The generation of the interference fringe is explained in more detail with reference to FIGS. 4 and 5. As will be understood, FIG. 4 is a very simplified illustration of the real optical situation encountered in an encoder apparatus. In particular, the situation is shown for only one light ray from the source whereas in fact an area of the incremental track 10 is illuminated by the source. Accordingly, in reality the optical situation shown in FIG. 4 is repeated many times over along the length of the scale (i.e. over the area that is illuminated by the source), hence producing a long interference pattern at the detector, which is schematically illustrated in FIG. 5. Also, for illustrative purposes only the +/−1^{st} orders are shown (e.g. as will be understood the light will be diffracted into multiple orders, e.g. +/−3^{rd}, +/−5^{th}, etc diffraction orders). The light is diffracted by the series of periodic features 14 in the incremental track 10 of the scale 6, and the diffraction orders propagate toward the diffraction grating 20 where the light is diffracted again before forming a resultant field 26 (in this case an interference fringe, but could for example be modulated spot(s)) at the incremental detector 22. As shown in FIG. 5, the resultant field 26 is produced by the recombination of diffracted orders of light from the diffraction grating 20 and scale 6.

For the sake of simplicity of illustration the ray diagrams in FIGS. 4 and 5 are shown as transmissive ray diagrams (that is the light is shown as being transmitted through each of the scale and diffraction grating), whereas in reality at least one of these could be reflective. For example, with the embodiment of FIGS. 1 and 2, the rays would be reflected from the scale 6.

The incremental detector 22 detects the resultant field 26 (e.g. the interference fringes) to produce a signal which is output by the readhead 4 to an external device such as controller 8. In particular, relative movement of the readhead 4 and scale 6 causes a change in the resultant field 26 (e.g. movement of the interference fringes relative to the detector 22 or a change in intensity of the modulated spot(s)) at the incremental detector 22), the output of which can be processed to provide an incremental up/down count which enables an incremental measurement of displacement.

The incremental detector 22 can comprise a plurality of photodiodes, for example. In particular, as will be understood, in embodiments in which an interference fringe 26 is produced at the incremental detector 22, the incremental detector 22 can be in the form of an electrograting, which in other words is a photo-sensor array which can for example comprise two or more sets of interdigitated/interlaced photo-sensitive sensors, each set detecting a different phase of the interference fringe 26 at the detector 22. An example is illustrated in FIG. 8, in which a part of an incremental detector 22 is shown, and in which the photodiodes of four sets of photodiodes A, B, C and D are interdigitated, and the outputs from each photodiode in a set are combined to provide a single output, A′, B′, C′ and D′. These outputs are then used to provide quadrature signals. For example, A′-C′ could be used to provide a first signal and B′-D′ could be used to provide a second signal which is 90 degrees out of phase from the first signal (e.g. Cos and Sin signals). As illustrated, at any one instant in time, all the photodiodes in any one set detect the intensity of same phase of the interference fringe (if the fringe period and sensor period are the same). This arrangement has the advantage that due to a filtering effect of the optics, the readhead 4 is largely immune to a disruption to the periodicity of the periodic scale marks 14. Thus, the presence of contamination and/or an embedded reference mark does not significantly affect the interference fringe detected by the incremental detector 22. More details of a scale and readhead of this type are described in U.S. Pat. No. 5,861,953, the entire contents of which are incorporated into this specification by this reference. As will be understood, the electrograting/photo-sensor array can take other forms, such as comprising only three sets of photodiodes that are interdigitated, and different layouts can be used.

With reference to the detection of a reference position, it will be understood that when the readhead 4 passes over the reference position, the feature 16 causes more light to be reflected back toward the reference photodetector 24. Accordingly, the readhead 4, and/or controller 8 can be configured to look for a change (in this case an increase) in the intensity of light received at the reference photodetector 24. As illustrated, in the embodiment described the reference photodetector 24 is actually a “split detector” which comprises first 28 and second separate detector channels offset relative to each other in the measuring direction. Each of these two separate detecting channels measure the intensity of light falling on it, and provides an output proportional to the intensity measured. In the embodiment described, no imaging optics is included and therefore simply a shadow-cast type arrangement exists for detecting the presence of the reference mark. That is, a shadow of the reference mark track 12 falls onto the two separate detecting channel 28, 30 by virtue of the reference track preventing (or at least reducing) the reflectance of light back toward the first 28 and second 30 detector channels. In other words, the reference photodetector 24 (and in particular the first 28 and second 30 detector channels) sit in the shadow of the scale's markings that define the reference mark feature 16 (that is, sit in the shadow of the features 59 in the reference mark track 12 which absorb light) for the majority of the scale's length, apart from when it is passes the reference position. When the readhead 4 passes over the reference mark 16, an increase in the amount of light reflected back to the readhead occurs. Depending on the direction of travel, one of the first 28 and second 30 detectors sees this increase before the other. The outputs of the first 28 and second 30 detecting channels therefore rise and fall as the readhead 4 passes the reference position, which is illustrated by the top portion of the graph in FIG. 3a.

As the first 28 and second 30 detecting channels are offset in the measuring direction, the rise and fall in intensity reported by one of the detecting channels lags behind the other. In this embodiment, the feature 16 and the first 28 and second 30 detector channels are configured such that the reference position can be determined by determining when a difference signal 38 of the outputs of the first 28 and second 30 detector channels (e.g. obtained by a differential amplifier) crosses between upper 43 and lower 45 threshold levels. As illustrated, this “zone” defined by the two threshold levels 43, 45 contains the point at which the two signals 28, 30 cross (at the point illustrated by line 34) and hence also contains the point at which the difference signal 38 crosses a zero value (e.g. at point 36). Accordingly, the reference position is actually determined as a reference “zone” 39 between two threshold levels 41, 43. When the difference signal is within this zone 39, a reference pulse, schematically illustrated by pulse 47 is output by the readhead 4 to the controller/processor device 8. The width of the reference pulse is not greater than one lissajous cycle of a lissajous which can be determined from the incremental quadrature signals. More details on detecting a reference position by obtaining the difference between outputs of two detecting channels is described in U.S. Pat. No. 7,624,513 and U.S. Pat. No. 7,289,042.

FIG. 3b illustrates the problem that occurs when the first 28 and second 30 reference mark detector channels become saturated by the light they receive from the reference mark 16. In this case, as illustrated the signals from the first and second reference mark detector channels rise and fall very sharply and have flat peaks which provide a very wide reference pulse, which covers multiple lissajous cycles of the lissajous signal determined from the incremental signals, which therefore provides a much less accurate reference mark determination. The invention can also be utilised in a transmissive encoder apparatus 202, as illustrated and explained below in connection with FIGS. 6 and 7. In this case, the scale 206 is primarily configured to allow light from the readhead's 204 light source 18 through it toward the incremental 22 and reference 24 photodetectors in the readhead 204 which are located on the opposite side of the scale 206 to the light source 18. For example, with reference to FIG. 7, the readhead 204 comprises a light source 18, an incremental detector 22, and a reference detector 24 (comprising first 28 and second 30 detector channels offset in the measuring direction (not shown)). These readhead components are substantially the same as that described in connection with the embodiments of FIGS. 1 to 5, and operate in the same way, the only difference being that the incremental 22 and reference 24 detectors are positioned on the opposite side of the scale 206 to the light source 18. Accordingly, an interference fringe (not shown) is created and detected at the incremental detector 22 in the same manner as described in connection with FIGS. 4 and 5. Likewise, the reference position is determined in the same way, that is, by finding the zero-crossing point of a difference signal obtained by differentially amplifying the output of the first 28 and second 30 detector channels of the reference detector 24. As shown, light blocking features 240 define the reference mark 216. The light blocking features 240 could for example absorb light, reflect light or redirect light away from the reference detector 24.

Our inventors have found that in arrangements such as those described above, the reference photodetector 24, and in particular the first 28 and second 30 detector channels can receive too much light, causing them to become saturated. This can lead to errors in the determination of the reference position. It has been found that reducing the sensitivity of part of the reference photodetector 24, and in particular part of the first 28 and second 30 detector channels, can improve the accuracy by which the reference position is determined. For instance, as illustrated in FIG. 1, first 40 and second 42 light restriction regions (in this case in the form of elongate bands) having reduced sensitivity are provided on each of the first 28 and second 30 detector channels. In the embodiment described, the first 40 and second 42 bands of reduced sensitivity are actually bands where the first 28 and second 30 channels are substantially insensitive to light falling on them. Accordingly, the total sensing area of the first channel 28 is less than the total physical area of the first channel 28 (and the same is true for the second channel 30). This can be achieved for example, by depositing a metallisation layer on top of a photosensitive layer of the photodetector. Optionally, this could be achieved by each photodetector channel being formed by linking the outputs of multiple separate and spaced photodetector channels together.

Referring to FIG. 12, two graphs illustrate the light sensitivity profile of the first channel 28 in both the X and Y dimensions (the same graphs would also be true for the second channel 30). As can be seen, the light sensitivity profile is non-uniform in the Y dimension (i.e. in the dimension perpendicular to the encoders/readhead's measuring dimension), in that the sensitivity “S” of the first channel 28 to light varies along the Y dimension. However, the light sensitivity profile is substantially uniform in the X dimension (i.e. in the dimension parallel to the encoders/readhead's measuring dimension), in that the sensitivity “S” of the first channel 28 to light does not vary along the X dimension. Such an arrangement can help when processing the signals obtained from the first 28 and second 30 channels because it can help to avoid unnecessary and adverse variations/steps in their signal output, even when dirt is present.

In the embodiment described above, the first 40 and second 42 bands completely block the light from reaching the photosensitive part/layer of the photodetector. However, this need not necessarily be the case, and the bands of reduced sensitivity could merely reduce the sensitivity of the detector channel as opposed to making it completely insensitive, for instance by only partially blocking light from reaching the photosensitive part/layer of the photodetector.

As will be understood, various other techniques may be used to identify the reference position. For instance, in order to aid the detection of the zero crossing, a gating signal might be used which identifies when the readhead is in the region of the reference position and configured the encoder apparatus to only look for the zero-crossing signal on activation of the gating signal. The gating signal could be obtained by using additional detector channels, and obtaining a sum signal as explained in more detail in U.S. Pat. No. 7,624,513 and U.S. Pat. No. 7,289,042. For example, FIG. 9 illustrates an alternative embodiment of a reference photodetector 24 which comprises first 28a, second 28b, third 30a and fourth 30b detector channels. In this case, a gating signal can be obtained by obtaining a “sum” and a “difference” signal as follows:

“sum”=(“28b”+“30a”)−(“28a”+“30b”)

“difference”=(“28a”+“28b”)−(“30a”+“30b”)

As can be seen, obtaining the difference signal essentially combines the outputs of first 28a and second 28b channels as one channel (equivalent to the first 28 channel of the embodiments of FIGS. 1 to 8) and the combines the outputs of third 30a and fourth 30b channels as one channel (equivalent to the second 30 channel of the embodiments of FIGS. 1 to 8). The sum signal 44 is illustrated on FIG. 3a and can be used to ensure that only a zero crossing obtained whilst the sum signal 44 is greater than a predetermined threshold level (illustrated by line 46) causes a reference position to be determined. This helps to avoid false triggers when zero-crossing signals are created by noise and/or errors in the signal obtained from the reference detector 224.

In the embodiments shown, first 40 and second 42 bands of reduced sensitivity are provided. However, as will be understood, other configurations are possible in order to reduce the sensitivity of the reference photodetector 24 and in particular of the detector channels. For example, at least one patch of reduced sensitivity could be provided which doesn't necessarily extend across the entire width of the photodetector/channel. An example of an alternative arrangement is illustrated in FIG. 10 in which the first 28 and second 30 detector channels comprise a plurality of angled light restriction regions 49, and hence a plurality of angled regions of normal sensitivity 51 (or in other words a set of regions of relatively greater sensitivity 51 and a set of regions of relatively lesser sensitivity 49). An example of another alternative arrangement is illustrated in FIG. 11 in which the first 28 and second 30 detector channels comprise a chequered arrangement of regions of relatively greater 51 and lesser 49 sensitivity.

As can be seen, in each of these embodiments, each of the reference mark detector channels 28, 30, define a notional rectangular (i.e. equiangular quadrilateral) region having sides that are parallel and perpendicular to measuring dimension B′, the position of the sides being defined by the reference mark's extent in and perpendicular to the measurement dimension. In the case of the embodiments of FIGS. 9, 10 and 11, the notional rectangular region for each channel is identified by the bold dashed line 53.

As can be seen, in all of these embodiments, the at least one reference mark photodetector channel is not uniformly sensitive in a dimension perpendicular to the measurement direction, along any line/cross-section extending perpendicular to the measuring direction. Furthermore, as can be seen, the total interaction area (e.g. the total sensing area of a reference mark photodetector channel or the total reflective area of a reflective reference mark) is less than the notional rectangular region defined by the extents of interaction (e.g. extents of the channel or extents of the reference mark) in and perpendicular to the measuring dimension.

In the described embodiment, the reference position is defined by a single-feature reference mark. However, it will be understood that this need not necessarily be the case. For instance, the reference mark could be defined by a pattern of features. In this case, detection of the reference position could be determined by looking for the pattern. Optionally, correlation techniques could be used to determine the presence of the reference position, such as those described in WO02/065061 or WO2005/012841.

Furthermore, in contrast to the above described embodiments, the reference position need not necessarily be determined by obtaining and analysing a difference signal. For instance, the readhead might comprise only a single detector channel the output of which is analysed, such that when it crosses a predetermined threshold, the reference position is considered to have been identified.

Optionally, additional features might be provided on the scale to signal to the readhead that it is in the region of a reference position and the readhead could be configured to only to look for a signal indicative of a reference position when it has received such a priming signal. Such features could be contained in another track on the scale, could be provided by a non-optical feature (e.g. a magnetic features detectable by hall sensors in the readhead), or could be optical feature contained in the same track as the reference mark 16.

In the embodiments described in connection with the reflective encoders in FIGS. 1 to 5, the light source 18 is shown to be located at a plane containing the incremental 24 and reference 24 photodetectors. However, as will be understood, this need not necessarily be the case. For instance, the light source 18 could be positioned above or below a plane containing the incremental 24 and/or reference 24 photodetectors (the incremental 24 and reference 24 photodetectors need not necessarily be in the same plane).

Furthermore, in the embodiments described in connection with the reflective encoders in FIGS. 1 to 5, the light source 18 is shown to be located between the incremental 22 and reference 24 photodetectors. Although this has been found to be a particular advantageous position (in particular to facilitate even distribution of light across the incremental 10 and reference 24 tracks on the scale which can help improve metrological performance), as will be understood this need not necessarily be the case. For instance, the light source 18 could be position to the side of the incremental 22 and reference 24 photodetectors in a direction transverse to the readhead's measuring direction.

As will be noted, in the embodiments described above, no lenses or other optical components which alter the wavefront curvature of light from the light source 18 are provided in the readhead. As will be understood, small, very weak lenses or optical components could be used, but preferably the optical power (in dioptres, m⁻¹) of such optical components is no greater than between −100 to 100, for example no greater than between −50 to 50, for instance no greater than between −10 to 10 and in particular no greater than between −5 to 5. The omission of such optical components (or the use of only very weak optical components) enables a very compact readhead to be provided. In particular, our inventors have been able to provide a readhead for use in a reflective encoder, the readhead having a total height of no more than 10 mm, and for example no more than 6.7 mm, with a total system height (top of readhead to top surface of scale) of less than 14 mm, and for example no more than 7.8 mm. Particularly, it has enabled the inventors to reduce the height between the incremental photodetector 22 and the diffraction/index grating 20 to no more than 2.3 mm.

Nevertheless, as will be understood, this need not necessarily be the case and for instance a lens could be used, e.g. in connection with either or both the incremental and reference optical systems. For example, a lens could be used to substantially collimate the light from the source before it hits the scale's incremental features. Furthermore, a lens could be used to provide an image of the scale, and hence the reference mark, on to the reference photodetector.

In the above described embodiments a divergent light source is used to illuminate both the incremental and reference mark tracks of the scale. In particular, no lens is used in the optical path of the incremental or reference mark systems of the encoder apparatus. In particular, no lens is used between the light emission component of the light source and the incremental or reference photodetectors. This can be advantageous because it can significantly reduce the size, and in particular the height, of the readhead. The absence of a lens can be advantageous even in encoder apparatus in which no reference mark system (e.g. no reference mark on the scale and/or reference mark photodetector(s)) is provided. Normally, in incremental encoders in which light from the source is initially diffracted by the scale and then the diffraction grating in the readhead so as to form an interference fringe at the incremental photodetector, the light source comprises a lens, such as a collimating lens, so as to significantly reduce the divergence of the light projected toward the scale. Indeed, this is the situation in the SiGNUM and TONiC encoders sold by Renishaw plc, and for instance is the situation described in WO2005/124282. However, our inventors have found that it can be advantageous to not use a lens in such a system (or only use a lens of insignificant power), for instance so as to make the readhead more compact. This is the case, whether or not the encoder apparatus utilises a reference mark.

In the above described embodiments the reference mark photodetector 24 comprises features for reducing the intensity of light it detects. However, the reference mark can itself comprise features for reducing the intensity of light passed on toward the reference mark photodetector, either instead of or as well as the reference mark photodetector. For instance, an encoder apparatus according to another aspect of the invention can comprise a readhead and a scale in which the reference mark comprises a non-reflective feature contained within an otherwise generally reflective reference mark.

1. An encoder apparatus for enabling relative position measurement between a scale and a readhead along a measurement direction, in which:
the scale comprises features that define a series of incremental scale marks and at least one reference mark defining at least one reference position along the measurement direction;
the readhead comprises a common light source for illuminating the incremental scale marks and at least one reference mark, at least one incremental photodetector, and at least one reference mark photodetector channel,
in which the at least one reference mark is configured to provide an increase in light from the common light source reaching the at least reference mark photodetector channel at the at least one reference position and in which:
the at least one reference mark is featured such that, within a notional rectangular region that has sides parallel and perpendicular to measuring dimension, the position of the sides being defined by the reference mark's extent in and perpendicular to the measurement dimension, there is non-uniform propagation of light intensity from the common light source toward the at least one reference mark photodetector channel at least in a dimension perpendicular to the measurement direction;
and/or,
the at least one reference mark photodetector channel is featured such that, within a notional rectangular region that has sides parallel and perpendicular to measuring dimension, the position of the sides being defined by the reference mark photodetector channel's extent in and perpendicular to the measurement dimension, the at least one reference mark photodetector channel is non-uniformly sensitive at least in a dimension perpendicular to the measurement direction.

2. An apparatus as claimed in claim 1, configured such that the output from the at least one reference mark photodetector channel is at or below the saturation point of at least one reference mark photodetector channel electronics.

3. An apparatus as claimed in claim 1, in which the at least one reference mark photodetector channel is configured such that within the notional rectangular region its light sensitivity profile in a direction perpendicular to the measuring dimension is non-uniform, and/or the at least one reference mark is configured such that within the notional rectangular region its light intensity propagation profile toward the at least one reference mark photodetector channel in a direction perpendicular to the measuring dimension is non-uniform.

4. An apparatus as claimed in claim 1, in which the at least one reference mark photodetector channel is configured such that within the notional rectangular region its light sensitivity profile in a direction parallel to the measuring dimension is uniform, and/or the at least one reference mark is configured such that within the notional rectangular region its light intensity propagation profile toward the at least one reference mark photodetector channel in a direction perpendicular to the measuring dimension is non-uniform.

5. An apparatus as claimed in claim 1, in which the at least one reference mark photodetector channel is configured such that the notional rectangular region comprises at least one discrete light restriction region having relatively reduced sensitivity, and/or the at least one reference mark comprises at least one discrete light restriction region having relatively reduced light intensity propagation properties toward the at least one reference mark photodetector.

6. An apparatus as claimed in claim 5, in which the at least one reference mark photodetector channel is configured such that the notional rectangular region comprises at least one band of relatively reduced sensitivity, and/or the at least one reference mark comprises at least one light restriction band.

7. An apparatus as claimed in claim 6, in which the at least one band extends parallel to the measuring direction.

8. An apparatus as claimed in claim 5, in which the at least one discrete region of the at least one reference mark photodetector channel is substantially insensitive to light and/or the at least one discrete light restriction region of the at least one reference mark substantially prevents light from reaching the at least one reference mark photodetector channel.

9. An apparatus as claimed in claim 1, in which the readhead comprises at least two reference mark detector channels, offset in the measuring direction, and optionally in which the total sensitivity of the at least two reference mark detector channels is the same.

10. An apparatus as claimed in claim 5, which the total area of the at least one discrete region is substantially the same for the at least two reference mark detector channels.

11. An apparatus as claimed in claim 10, in which the at least two reference mark detector channels have the same arrangement of said at least one discrete region of reduced sensitivity.

12. An apparatus as claimed in claim 9, configured to obtain a difference signal of at least two detector channels in order to determine the reference position.

13. An apparatus as claimed in claim 1, in which the readhead comprises a diffraction grating, and in which the light from the source interacts with the incremental scale marks and the at least one diffraction grating to produce diffraction orders which combine to produce at the at least one photodetector a resultant field which varies with relative movement of the scale and readhead.

14. A readhead for reading a scale along a measurement direction, the readhead comprising a light source for illuminating a scale, an incremental photodetector for reading incremental scale marks on the scale, and at least one reference mark detector channel for detecting at least one bright reference mark on the scale, in which the at least one reference mark detector channel comprises at least one elongate band of reduced sensitivity which extends along the readhead's measurement dimension.

15. An encoder apparatus for enabling relative position measurement between a scale and a readhead along a measurement direction, comprising:
a scale comprising incremental scale marks and at least one bright reference mark;
a readhead comprising a light source for illuminating the incremental and reference marks, an incremental photodetector for reading the incremental scale marks, and at least one reference mark detector channel for detecting the at least one reference mark;
in which the at least one reference mark detector channel comprises at least one elongate band of reduced sensitivity extending along the measurement dimension.

16. An encoder apparatus comprising scale having at least one bright reference mark and a readhead for reading the scale comprising at least one reference mark photodetector channel, and in which the reference mark and/or the at least one reference mark photodetector channel detector comprises at least one light restriction feature which is configured to reduce the intensity of light detected by the at least one reference mark photodetector channel such that the output from the at least one reference mark photodetector channel is at or below the saturation point of the at least one reference mark photodetector channel electronics.

17. A readhead for reading a scale along a measurement direction, the readhead comprising a light source for illuminating a scale, at least one reference mark detector channel for detecting at least one reference mark on the scale, in which the at least one reference mark detector channel comprises at least one region over which a metallisation layer has been applied so as to at least partially block light from reaching the photosensitive part of the at least one reference mark detector channel.
